(19) United States
(12) Patent Application Publication
(10) Pub. No.: US 2021/0318689 A1
(43) Pub. Date: Oct. 14, 2021

(54) VACUUM CLEANER SYSTEM AND VACUUM CLEANER

(71) Applicant: Panasonic Intellectual Property Management Co., Ltd., Osaka (JP)

(72) Inventors: Yuta MIURA, Osaka (JP); Renji Honda, Nara (JP); Yuko Tsusaka, Kyoto (JP)

(21) Appl. No.: 17/224,910

(22) Filed: Apr. 7, 2021

(30) Foreign Application Priority Data
Apr. 10, 2020 (JP) 2020-070920

(51) Int. Cl. G05D 1/02; A47L 9/28

(52) U.S. Cl. CPC G05D 1/0234; G05D 1/0274; A47L 2201/04; G05D 2201/0215; A47L 9/2805

(57) ABSTRACT

A vacuum cleaner system includes a vacuum cleaner and a first marker allowed to be placed in a cleaning area, and the vacuum cleaner includes a map acquisition unit that acquires a map, a positional relationship acquisition unit that acquires a first positional relationship indicating a positional relationship between the vacuum cleaner and the first marker in the cleaning area, and a marker information acquisition unit that acquires first marker information carried by the first marker. The vacuum cleaner system further includes a cleaning plan construction unit that constructs a cleaning plan in the map based on the first marker information, the first positional relationship, and a self-position of the vacuum cleaner in the map. This provides a vacuum cleaner system capable of automatically constructing a cleaning plan.

### BACKGROUND

### 1. Technical Field

The present disclosure relates to a vacuum cleaner that autonomously travels in a predetermined area to clean the predetermined area, and a vacuum cleaner system.

### 2. Description of the Related Art

For example, Unexamined Japanese Patent Publication No. 2014-21624 (hereinafter referred to as “PTL 1”) discloses a vacuum cleaner in the related art, the vacuum cleaner being configured to accurately acquire a self-position of the vacuum cleaner based on information carried by a marker attached to a cleaning area and autonomously travel for cleaning.

However, it is required that a vacuum cleaner used for cleaning a relatively large area such as an office building, a hotel, a shopping complex, or a factory have not only a capability of accurately grasping the self-position but also a capability of performing cleaning based on a cleaning plan that specifies details of cleaning applied to a predetermined area in a map.

### SUMMARY

The present disclosure provides a vacuum cleaner system capable of constructing a cleaning plan using a vacuum cleaner and a vacuum cleaner included in the vacuum cleaner system.

Provided according to the present disclosure is a vacuum cleaner system including a vacuum cleaner that autonomously travels in a predetermined cleaning area to dean the predetermined cleaning area. The vacuum cleaner system includes a first marker allowed to be placed in the cleaning area and a map acquisition unit that acquires a map of the cleaning area. The vacuum cleaner includes a positional relationship acquisition unit that acquires a first positional relationship indicating a positional relationship between the vacuum cleaner and the first marker in the cleaning area, and a marker information acquisition unit that acquires first marker information carried by the first marker. The vacuum cleaner system further includes a cleaning plan construction unit that constructs a cleaning plan in the map based on the first marker information, the first positional relationship, and a self-position corresponding to information on a position of the vacuum cleaner in the map.

Further, provided according to the present disclosure is a vacuum cleaner included in a vacuum cleaner system. The vacuum cleaner includes a map acquisition unit that acquires a map of a cleaning area, and a positional relationship detector that detects a first positional relationship between the vacuum cleaner and a first marker included in the vacuum cleaner system in the cleaning area. The vacuum cleaner further includes a positional relationship acquisition unit that acquires the first positional relationship detected by the positional relationship detector, an information detector that detects first marker information carried by the first marker, and a marker information acquisition unit that acquires the first marker information detected by the information detector.

According to the present disclosure, a vacuum cleaner system capable of easily constructing a cleaning plan and a vacuum cleaner included in the vacuum cleaner system can be provided.

### BRIEF DESCRIPTION OF THE DRAWINGS

FIG. 1 is a diagram showing, together with a floor to be cleaned, a vacuum cleaner system including a cleaning information providing device according to an exemplary embodiment;

FIG. 2 is a perspective view of a first example of a first marker according to the exemplary embodiment;

FIG. 3 is a perspective view of a second example of the first marker according to the exemplary embodiment;

FIG. 4 is a perspective view of a third example of the first marker according to the exemplary embodiment;

FIG. 5 is a side view of a vacuum cleaner according to the exemplary embodiment, showing an external appearance of the vacuum cleaner;

FIG. 6 is a bottom view of the vacuum cleaner according to the exemplary embodiment, showing the external appearance of the vacuum cleaner;

FIG. 7 is a block diagram of functional units of the vacuum cleaner system according to the exemplary embodiment; and

FIG. 8 is a flowchart showing an operation flow of the vacuum cleaner system according to the exemplary embodiment.

### DETAILED DESCRIPTION

A description will be given below, with reference to the drawings, of an outline of a vacuum cleaner system and a vacuum cleaner included in the vacuum cleaner system according to an exemplary embodiment of the present disclosure.

Note that the following exemplary embodiment is merely illustrative of the vacuum cleaner system and the vacuum cleaner according to the present disclosure. Therefore, the present disclosure is defined by the recitation in the claims with reference to the following exemplary embodiment, and is not limited to the following exemplary embodiment. Components according to the following exemplary embodiment that are not recited in any of the independent claims representing the most generic concept of the present disclosure are not essential for achievement of the object of the present disclosure, but are described as components used for implementing a more preferred form.

Further, the drawings are schematic drawings in which emphasis, omission, and scale adjustment are made as required for illustration of the present disclosure, and may be different from a real shape, positional relationship, or scale.

### Exemplary Embodiment

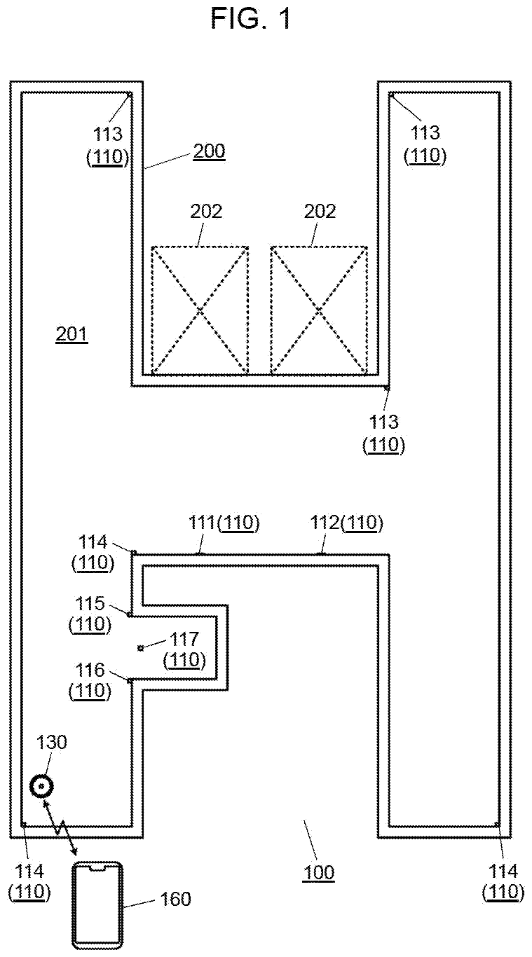

A description will be given below, with reference to FIGS. 1 to 4, of the outline of the vacuum cleaner system and the vacuum cleaner included in the vacuum cleaner system according to the exemplary embodiment of the present disclosure.

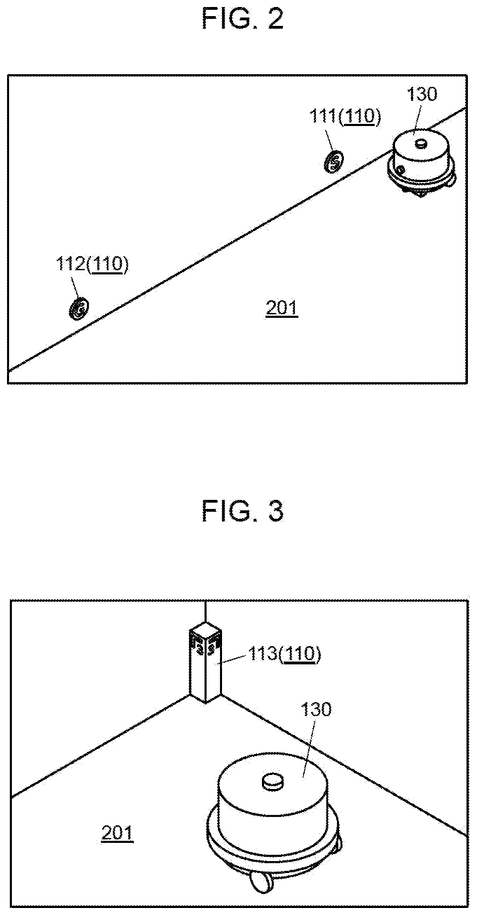

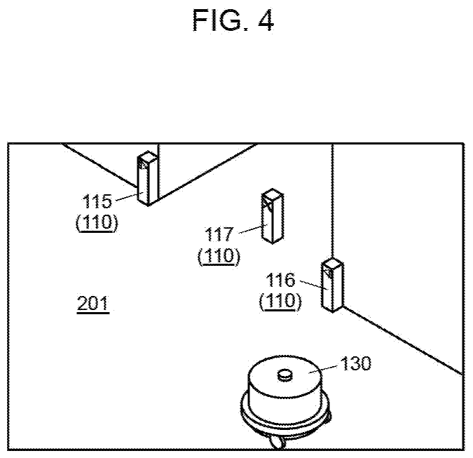

FIG. 1 is a diagram showing, together with a floor to be cleaned, vacuum cleaner system 100 including a cleaning information providing device (terminal device) according to the exemplary embodiment. FIG. 2 is a perspective view of a first example of a first marker according to the exemplary embodiment. FIG. 3 is a perspective view of a second example of the first marker according to the exemplary embodiment. FIG. 4 is a perspective view of a third example of the first marker according to the exemplary embodiment.

Vacuum cleaner system 100 according to the exemplary embodiment constructs a cleaning plan for cleaning area 201 such as a floor of facility 200 such as a hotel or a tenant-occupied building. Vacuum cleaner system 100 is a system that allows vacuum cleaner 130 to autonomously perform cleaning in accordance with the cleaning plan thus constructed.

As shown in FIGS. 1 to 4, vacuum cleaner system 100 includes vacuum cleaner 130, first marker 110, and the like. Note that, according to the present exemplary embodiment, vacuum cleaner system 100 further includes terminal device 160 (cleaning information providing device).

First marker 110 is a member allowed to be placed in cleaning area 201. Specifically, first marker 110 is a member used for associating a real position with a virtual position in a map during the construction of the cleaning plan.

Note that first marker 110 is preferably a member allowed to be detached after the cleaning plan is constructed. Further, a shape of first marker 110 is not limited to any specific shape. Examples of the shape of first marker 110 include a sheet shape that allows first marker 110 to be attached to a wall, a door, furniture, or the like, a pillar shape or cone shape that allows first marker 110 to be placed on a floor, a rod shape with an L-shaped cross section that allows first marker 110 to be placed at a corner of a bend, and the like.

First marker 110 carries first marker information. Note that how first marker 110 carries the first marker information is not limited to any specific form. According to the present exemplary embodiment, first marker 110 is marked with a sign associated with the first marker information, such as a one-dimensional code, a two-dimensional code, a specific pattern, a text, a symbol, or a picture, to carry the first marker information. Further, the sign marked on first marker 110 as the first marker information is, for example, a visible sign that allows a person to understand what the first marker information shows. This facilitates work of placing first marker 110 in cleaning area 201 as compared with a case where only a one-dimensional code or a two-dimensional code is marked. A sign such as a one-dimensional code or a two-dimensional code that can be easily identified by a device included in vacuum cleaner 130 and a sign such as a letter or a picture that can be easily recognized by a person may be written together. This prevents the vacuum cleaner from erroneously recognizing first marker 110 as a different marker. This further prevents a person from erroneously placing a marker different from a marker that should be placed.

First marker 110 may further include an element such as a radio frequency (RF) tag capable of carrying the first marker information in an electromagnetic form. This allows first marker 110 to be configured to transmit the first marker information via an electromagnetic wave, light, or the like. First marker 110 may be marked with another sign such as a letter or a picture that can be easily recognized by a person.

That is, vacuum cleaner system 100 according to the present exemplary embodiment includes, in cleaning area 201, a plurality of first markers 110 exemplified by, for example, a first example, a second example, and a third example. For example, first marker 110 may include, as the first example, start marker 111, goal marker 112, and the like. Start marker 111 shows, for example, a letter “S” as shown in FIG. 2 and carries start information showing a cleaning start position. Goal marker 112 shows, for example, a letter “G” and carries goal information showing a cleaning end position.

First marker 110 may further include, as the second example, first corner marker 113 as shown in FIG. 3, second corner marker 114, and the like. First corner marker 113 carries first corner information showing a corner of a rectangular area used in the cleaning plan. Second corner marker 114 carries second corner information showing a corner diagonally opposite to first corner marker 113 in the rectangular area. At least either first corner marker 113 or second corner marker 114 may carry, as the first marker information, cleaning information showing a cleaning mode in the rectangular area defined by first corner marker 113 and second corner marker 114. Note that examples of the above-described cleaning information include information showing a suction power level of the vacuum cleaner such as “high”, “medium”, and “low”, information showing n round trips (n is an integer) in the rectangular area, information indicating a travel speed of vacuum cleaner 130, and the like. According to the present exemplary embodiment, as shown in FIG. 3, a plurality of numbers (3) associated with an available cleaning mode are marked on a surface of first marker 110.

First marker 110 may further include, as the third example, first regulation line marker 115, second regulation line marker 116, no-entry marker 117, and the like as shown in FIG. 4. First regulation line marker 115 carries first regulation line information showing a first end of a cross-border regulation line. Second regulation line marker 116 carries second regulation line information showing a second end of the cross-border regulation line. No-entry marker 117 carries no-entry information indicating a no-entry area of vacuum cleaner 130. No-entry marker 117 showing which side of the line connecting first regulation line marker 115 and second regulation line marker 116 is the no-entry area may serve as one of first markers 110.

Further, according to the present exemplary embodiment, at least some of the plurality of first markers 110 may serve as second markers that are used as markers when the map is constructed. Specifically, for example, first corner marker 113 and second corner marker 114 are placed at all corners of cleaning area 201. Then, rectangular areas defined by a plurality of sets of first corner markers 113 and second corner markers 114 are connected. This allows the second markers to contribute to the construction of the map of cleaning area 201. First corner marker 113 and second corner marker 114 may be provided with, for example, a mirror-like reflective member that strongly reflects light emitted by positional relationship detector 136 to be described later. This allows positional relationship detector 136 to recognize first corner marker 113 and second corner marker 114.

As described above, the outline of vacuum cleaner system 100 and vacuum cleaner 130 included in vacuum cleaner system 100 according to the present exemplary embodiment is defined.

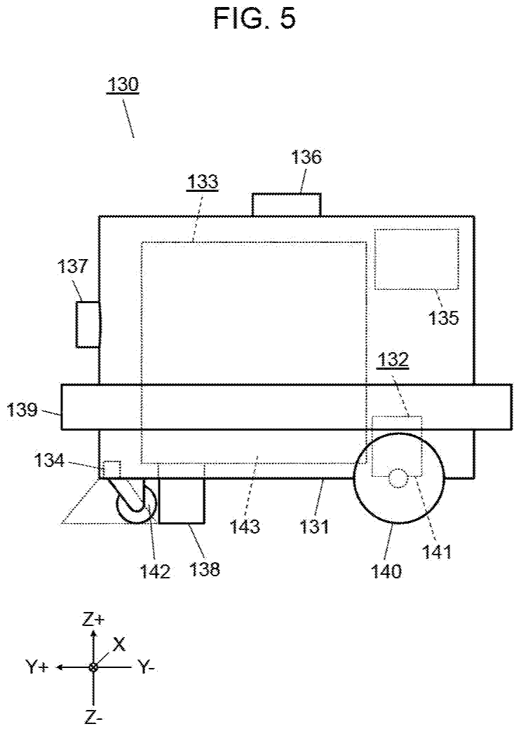

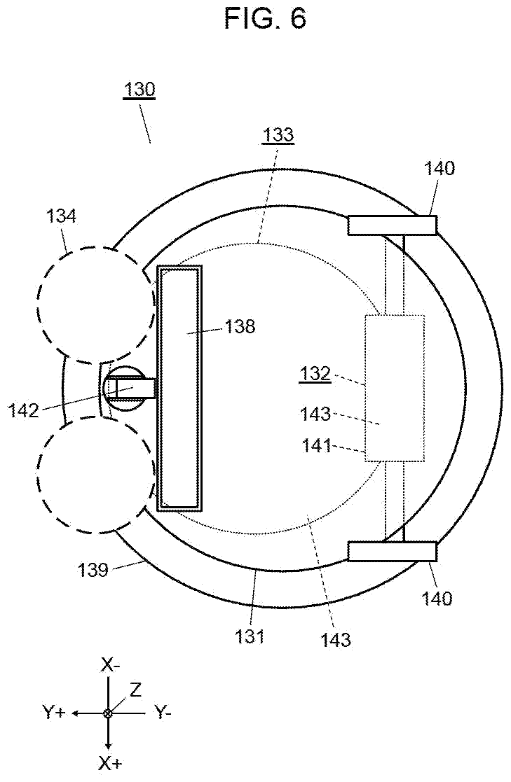

A description will be given below of vacuum cleaner 130 according to the present exemplary embodiment with reference to FIGS. 5 and 6.

FIG. 5 is a side view of vacuum cleaner 130 according to the exemplary embodiment, showing an external appearance of vacuum cleaner 130. FIG. 6 is a bottom view of vacuum cleaner 130 according to the exemplary embodiment, showing the external appearance of vacuum cleaner 130.

As shown in FIGS. 5 and 6, vacuum cleaner 130 according to the present exemplary embodiment is a robot vacuum cleaner that autonomously travels in all or part of cleaning area 201 to be cleaned, such as a common area of a floor and sucks dust lying in cleaning area 201.

Specifically, vacuum cleaner 130 according to the present exemplary embodiment includes body 131 having various components mounted therein, drive unit 132, cleaning unit 134, suction unit 133, control unit 135, positional relationship detector 136, and information detector 137 (see FIG. 2). Drive unit 132 moves body 131 in cleaning area 201. Cleaning unit 134 collects dust lying in cleaning area 201. Suction unit 133 sucks dust into body 131. Control unit 135 controls drive unit 132, cleaning unit 134, suction unit 133, and the like. Note that positional relationship detector 136 and information detector 137 will be described later.

Body 131 serves as a housing that encloses drive unit 132, control unit 135, and the like. An upper part of body 131 is removable relative to a lower part of body 131. Further, body 131 includes bumper 139 that is attached to a periphery of body 131 and can be displaced relative to body 131. Body 131 further includes, as shown in FIG. 3, suction port 138 provided in the lower part of body 131 through which dust is sucked into body 131.

Drive unit 132 is a device that moves vacuum cleaner 130 in accordance with a command from control unit 135. Drive unit 132 includes wheel 140 that travels on a surface to be cleaned of the floor that is cleaning area 201, a traveling motor (not shown) that applies torque to wheel 140, housing 141 that encloses the traveling motor, and the like.

Body 131 further includes caster 142 that is provided on a bottom surface of body 131 and serves as a guide wheel. Vacuum cleaner 130 then controls rotation of each of two wheels 140. This allows vacuum cleaner 130 to freely travel forward, backward, counterclockwise, clockwise, or the like.

Cleaning unit 134 serves as a unit that sweeps up dust on the floor that is cleaning area 201 and sucks the dust through suction port 138. Cleaning unit 134 includes a rotary brush disposed near suction port 138, a brush drive motor that rotates the rotary brush, and the like.

Suction unit 133 serves as a unit that sucks dust through suction port 138 and holds the dust sucked into body 131. Suction unit 133 includes an electric fan (not shown), dust container 143, and the like. The electric fan causes air inside dust container 143 to be sucked out of body 131. As a result, the electric fan causes dust to be sucked through the suction port 138 and collected into dust container 143.

Further, positional relationship detector 136 is a device that detects a first positional relationship between vacuum cleaner 130 and first marker 110 in cleaning area 201. Positional relationship detector 136 detects a direction of and a distance to an obstacle such as first marker 110, a wall, or furniture located around body 131 to acquire a two-and-a-half-dimensional information.

Note that vacuum cleaner 130 according to the present exemplary embodiment is capable of grasping a self-position of vacuum cleaner 130 from the information on the direction and the distance detected by positional relationship detector 136. Further, positional relationship detector 136 is not limited to any specific type, and, for example, a light detection and ranging (LiDAR), a time of fight (ToF) camera, and the like that emit light and detect a position and distance based on light reflected off an obstacle can be given as examples.

As an example of positional relationship detector 136, a stereo camera or the like that receives, as an image, illumination light or natural light reflected off an obstacle and acquires a position and distance based on disparity can be given.

Information detector 137 is a device that detects the first marker information carried by first marker 110. Note that how information detector 137 detects the first marker information is not limited to any specific method as long as the method is compatible with how first marker 110 carries the first marker information. That is, according to the present exemplary embodiment, first marker 110 carries and presents the first marker information in the form of a sign marked on the surface of first marker 110. Therefore, as information detector 137, a digital camera capable of detecting the sign marked on first marker 110 as image data is employed. When positional relationship detector 136 is capable of detecting the first marker information, positional relationship detector 136 may serve as information detector 137.

Note that vacuum cleaner 130 according to the present exemplary embodiment may include another sensor in addition to positional relationship detector 136 and information detector 137.

For example, vacuum cleaner 130 may include a floor surface sensor that is disposed at a plurality of places on the bottom surface of body 131 and detects whether the floor surface as cleaning area 201 exists. Vacuum cleaner 130 may include an encoder that is installed in drive unit 132 and detects respective rotation angles of the pair of wheels 140 rotated by the traveling motor. Vacuum cleaner 130 may include an acceleration sensor that detects acceleration when vacuum cleaner 130 travels and an angular acceleration sensor that detects angular acceleration when vacuum cleaner 130 turns. Vacuum cleaner 130 may include a dust volume sensor that measures a volume of dust accumulated on the floor surface. Vacuum cleaner 130 may include a contact sensor that detects displacement of bumper 139 to detect a collision with an obstacle. Furthermore, vacuum cleaner 130 may include, in addition to positional relationship detector 136, an obstacle sensor such as an ultrasonic sensor that detects an obstacle located in front of body 131.

Terminal device 160 (see FIG. 1) is made up of a computer or the like capable of executing a program to implement various functions. According to the present exemplary embodiment, terminal device 160 is, for example, a device such as a smartphone or a tablet terminal. This allows terminal device 160 to communicate various information with vacuum cleaner 130.

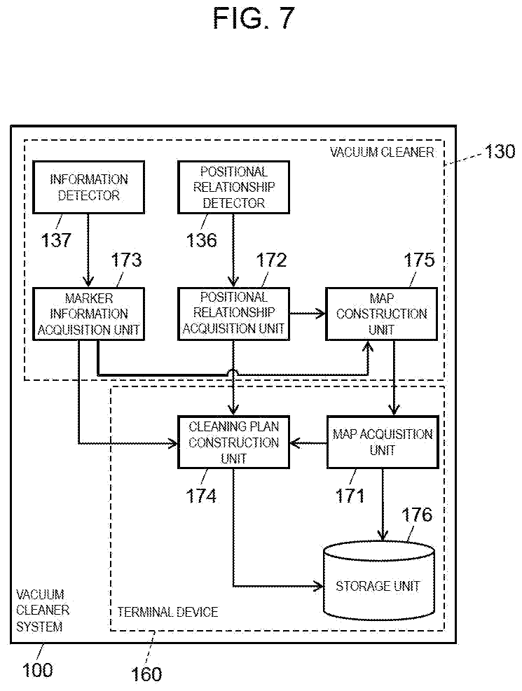

Next, a description will be given, with reference to FIG. 7, of functional units of vacuum cleaner system 100 according to the present exemplary embodiment.

FIG. 7 is a block diagram showing the functional units of vacuum cleaner system 100 according to the present exemplary embodiment.

As shown in FIG. 7, vacuum cleaner system 100 according to the present exemplary embodiment includes functional units such as map acquisition unit 171, positional relationship acquisition unit 172, marker information acquisition unit 173, and cleaning plan construction unit 174. According to the present exemplary embodiment, vacuum cleaner system 100 further includes functional units such as map construction unit 175 and storage unit 176.

Positional relationship acquisition unit 172 of vacuum cleaner 130 acquires, from positional relationship detector 136, the first positional relationship that is a positional relationship between vacuum cleaner 130 and first marker 110 in cleaning area 201. Note that, according to the present exemplary embodiment, first corner marker 113, second corner marker 114, and the like serving as first markers 110 also serve as second markers that present information necessary for map construction unit 175 to construct the map. Positional relationship acquisition unit 172 further acquires, from positional relationship detector 136, a second positional relationship that is a positional relationship between vacuum cleaner 130 and first marker 110 serving as the second marker.

Map construction unit 175 of vacuum cleaner 130 constructs the map based on the second positional relationship between vacuum cleaner 130 and the second marker acquired by positional relationship acquisition unit 172. Note that how to construct the map is not limited to any specific method, but according to the present exemplary embodiment, the map is constructed by simultaneous localization and mapping (SLAM). The map thus constructed is stored in storage unit 176 of terminal device 160.

Map acquisition unit 171 of terminal device 160 acquires the map of cleaning area 201. Note that a source from which the map is acquired is not limited to any specific source. For example, map acquisition unit 171 may acquire, as the map of cleaning area 201, floor data designed in advance by computer-aided design (CAD) or the like. Further, map acquisition unit 171 may acquire a map constructed by another vacuum cleaner or the like. Furthermore, map acquisition unit 171 may acquire a map modified by terminal device 160.

According to the present exemplary embodiment, vacuum cleaner 130 constructs, without interruption, the map by SLAM including the second positional relationship acquired while traveling in cleaning area 201. Therefore, map acquisition unit 171 acquires the map under construction without interruption.

Marker information acquisition unit 173 of vacuum cleaner 130 acquires the first marker information carried by first marker 110. For example, when first marker 110 outputs the first marker information via a radio wave or light, marker information acquisition unit 173 acquires the first marker information from information detector 137 that receives the radio wave or light. Specifically, according to the present exemplary embodiment, the first marker information is carried in the form of a sign marked on the surface of first marker 110. Therefore, information detector 137 acquires the sign carrying the first marker information as image data. Further, marker information acquisition unit 173 image-analyzes the image data acquired from information detector 137. As a result, marker information acquisition unit 173 identifies the sign from the image data thus image-analyzed and acquires information associated with the sign as the first marker information.

Note that marker information acquisition unit 173 may acquire second marker information from the second marker. Map construction unit 175 uses the second marker information acquired by marker information acquisition unit 173 to construct the map.

Then, cleaning plan construction unit 174 of terminal device 160 constructs the cleaning plan in the map based on the first marker information, the first positional relationship, the map acquired by map acquisition unit 171, and the self-position corresponding to information on the position of vacuum cleaner 130 in the map. At this time, the self-position corresponding to the information on the position of vacuum cleaner 130 in the map includes information acquired from the other sensors such as an encoder included in vacuum cleaner 130 in addition to the information acquired from positional relationship detector 136. Then, the cleaning plan thus constructed is stored in storage unit 176 of terminal device 160.

Herein, the cleaning plan corresponds to information including information for partitioning cleaning area 201 into sections and information showing a cleaning mode in each section. The cleaning mode includes, for example, the suction power of suction unit 133, the travel speed of vacuum cleaner 130 driven by drive unit 132, the travel path of vacuum cleaner 130, and the like. As a specific example of the cleaning plan, as shown in FIG. 1, for example, an assumption is made that the largest number of people pass through an area in front of elevators 202. Therefore, for the area in front of elevators 202 defined by first corner marker 113 and second corner marker 114, the above-described cleaning plan includes information showing a cleaning mode stricter than cleaning modes of the other areas.

The functional units of vacuum cleaner system 100 according to the present exemplary embodiment are configured to function as described above.

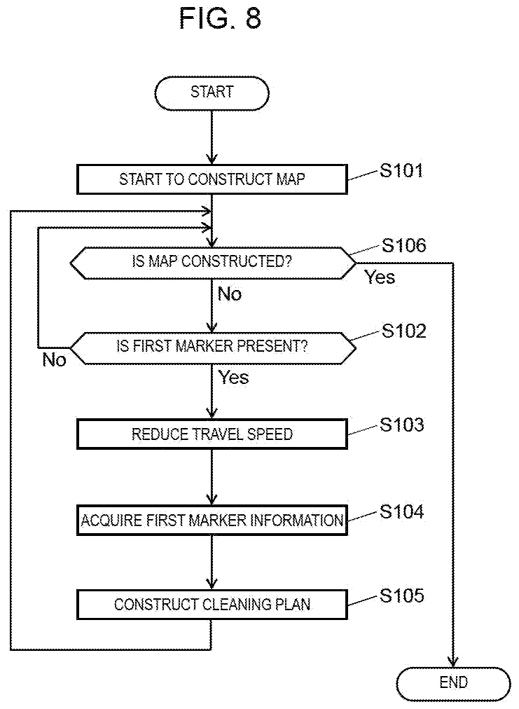

Next, a description will be given of operation of vacuum cleaner system 100 with reference to FIG. 8.

FIG. 8 is a flowchart showing an operation flow of vacuum cleaner system 100 according to the present exemplary embodiment.

As shown in FIG. 8, vacuum cleaner 130 first starts autonomous traveling from a predetermined position. Then, vacuum cleaner 130 starts to construct a map based on information from positional relationship acquisition unit 172 and the other sensors such as an encoder (step S101).

Next, vacuum cleaner 130 traveling for constructing the map checks for first marker 110 via at least either information detector 137 or marker information acquisition unit 173 (step S102). When a result of the check shows that first marker 110 is present (Yes in step S102), the travel speed of vacuum cleaner 130 is reduced in order to facilitate the acquisition of the first marker information, and the travel speed is maintained until the first marker information is acquired (step S103). This facilitates the acquisition of the first marker information. In this case, vacuum cleaner 130 may be brought closer to first marker 110 to acquire the first marker information. This facilitates the acquisition of the first marker information.

Next, vacuum cleaner 130 acquires the first marker information from first marker 110 via information detector 137 (step S104). Note that, as described above, when first marker 110 also serves as the second marker, information detector 137 may acquire the second marker information.

Next, based on the first marker information thus acquired, a cleaning plan associated with the map under construction is constructed (step S105).

Then, step S102 to step S105 are repeatedly executed until the map is fully constructed (Yes in step S106).

That is, vacuum cleaner system 100 according to the present exemplary embodiment causes, while checking an actual floor condition, first marker 110 of a type suitable for the floor condition to be placed and automatically constructs the cleaning plan in a manner that depends on the type of first marker 110. This allows anyone to easily construct a suitable cleaning plan via vacuum cleaner 130.

Further, first marker 110 is placed on the actual floor, and vacuum cleaner 130 is caused to autonomously travel on the floor. This allows the map corresponding to information showing the floor to be constructed by SLAM or the like and allows the cleaning plan to be automatically constructed at the same time. Initial settings for causing vacuum cleaner 130 to clean another floor can be simplified accordingly.

Note that the present disclosure is not limited to the exemplary embodiment. For example, the exemplary embodiment according to the present disclosure may include a different exemplary embodiment implemented with any combination of the components described herein or implemented without some of the components. Further, modifications obtained by applying, to the exemplary embodiment, various modifications that may be conceived of by those skilled in the art without departing from the spirit of the present disclosure, that is to say, meaning of the recitation in the claims are included in the present disclosure.

For example, according to the exemplary embodiment, the sign marked on first marker 110 may be made of a reflective material that strongly reflects the light emitted by positional relationship detector 136.

Further, the example according to the exemplary embodiment where first marker 110 also serves as the second marker has been described, but the present disclosure is not limited to such an example. For example, the second marker may be placed on the floor separately from first marker 110.

Further, the configuration according to the exemplary embodiment where vacuum cleaner system 100 includes terminal device 160 has been described, but the present disclosure is not limited to such a configuration. For example, vacuum cleaner system 100 need not include terminal device 160.

Further, according to the exemplary embodiment, either vacuum cleaner 130 or terminal device 160 may include a processing unit implemented through the execution of the program. Further, vacuum cleaner 130 and terminal device 160 may each include a part of the processing unit implemented through the execution of the program.

Further, the example according to the exemplary embodiment where the cleaning plan and the map are concurrently constructed has been described, but the present disclosure is not limited to such an example. For example, when the map has been acquired separately, vacuum cleaner 130 may be caused to autonomously travel to construct only the cleaning plan.

Further, the example according to the exemplary embodiment where the map is defined as a rectangular area has been described, but the present disclosure is not limited to such an example. For example, first markers 110 each serving as a vertex of a triangle may be placed on the floor to define the map as a triangular area, and the cleaning plan may be constructed based on the triangular area thus defined. Alternatively, first markers 110 may be placed at three different points on an are to define an area having a boundary partially or entirely made of the arc.

Further, according to the exemplary embodiment, the cleaning plan constructed based on first marker 110 may be manually modified by a user via terminal device 160 or the like.

Further, the example according to the exemplary embodiment where the cleaning plan is constructed by one vacuum cleaner 130 has been described, but the present disclosure is not limited to such an example. For example, a plurality of vacuum cleaners 130 may be caused to travel in cleaning area 201 to construct the map or the cleaning plan. This requires terminal device 160 to be capable of communicating with the plurality of vacuum cleaners 130. Then, terminal device 160 may unify pieces of information from the plurality of vacuum cleaners 130 to construct the map or the cleaning plan.

What is claimed is:

1. A vacuum cleaner system comprising:
a vacuum cleaner that autonomously travels in a cleaning area that has been predetermined to clean the cleaning area;
a first marker allowed to be placed in the cleaning area; and
a map acquisition unit that acquires a map of the cleaning area, wherein
the vacuum cleaner includes a positional relationship acquisition unit that acquires a first positional relationship indicating a positional relationship between the vacuum cleaner and the first marker in the cleaning area, and a marker information acquisition unit that acquires first marker information carried by the first marker, and
the vacuum cleaner system further comprises a cleaning plan construction unit that constructs a cleaning plan in the map based on the first marker information, the first positional relationship, and a self-position corresponding to information on a position of the vacuum cleaner in the map.

2. The vacuum cleaner system according to claim 1 further comprising:
a second marker allowed to be placed in the cleaning area; and
a map construction unit that constructs the map based on a second positional relationship between the vacuum cleaner and the second marker acquired by the positional relationship acquisition unit,
wherein the map acquisition unit acquires, without interruption, the map under construction by the map construction unit, and
the cleaning plan construction unit constructs, without interruption, the cleaning plan based on the map under construction acquired by the map acquisition unit.

3. The vacuum cleaner system according to claim 1 further comprising a terminal device including the cleaning plan construction unit.

4. The vacuum cleaner system according to claim 1, wherein the first marker includes a start marker that carries, as the first marker information, start information showing a cleaning start position and a goal marker that carries, as the first marker information, goal information showing a cleaning end position.

5. The vacuum cleaner system according to claim 1, wherein the first marker includes a first corner marker that carries, as the first marker information, first corner information showing a corner of a rectangular area used in the cleaning plan and second corner marker that carries, as the first marker information, second corner information showing a corner diagonally opposite to the first corner marker in the rectangular area.

6. The vacuum cleaner system according to claim 5, wherein at least either the first corner marker or the second corner marker carries, as the first marker information, cleaning information showing a cleaning mode in the rectangular area defined by the first corner marker and the second corner marker.

7. The vacuum cleaner system according to claim 1, wherein the first marker includes a first regulation line marker that carries, as the first marker information, first regulation line information showing a first end of a cross-border regulation line and a second regulation line marker that carries, as the first marker information, second regulation line information showing a second end of the cross-border regulation line.

8. A vacuum cleaner included in a vacuum cleaner system according to claim 1, the vacuum cleaner comprising:
a map acquisition unit that acquires a map of a cleaning area;
a positional relationship detector that detects a first positional relationship between the vacuum cleaner and a first marker included in the vacuum cleaner system in the cleaning area;
a positional relationship acquisition unit that acquires the first positional relationship detected by the positional relationship detector;
an information detector that detects first marker information carried by the first marker; and
a marker information acquisition unit that acquires the first marker information detected by the information detector.
